(19) United States
(12) Patent Application Publication
(10) Pub. No.: US 2010/0262302 A1
(43) Pub. Date: Oct. 14, 2010

(54) Plasma processing apparatus, fault detection apparatus, and fault detection method

(75) Inventor: Takashi Yamane, Kumamoto (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki-shi (JP)

(21) Appl. No.: 12/659,989

(22) Filed: Mar. 26, 2010

(30) Foreign Application Priority Data
Apr. 13, 2009 (JP) 2009-097188

(51) Int. Cl. G05D 16/20; G05D 7/06

(52) U.S. Cl. 700/282

(57) ABSTRACT

Gas introduction piping introduces process gas for plasma generation into a processing chamber. A pressure regulating valve is provided at an exhaust pipe. A mass flow controller is provided at the gas introduction piping and regulates the flow rate of the process gas. A pressure gauge detects the pressure of the processing chamber. A control unit controls pressure within the processing chamber by controlling an extent of opening of the pressure regulating valve based on values detected by the pressure gauge. The control unit receives flow rate data indicating the rate of flow of process gas from the mass flow controller and determines the presence or absence of faults at the mass flow controller based on an extent of fluctuation of the values detected by the pressure gauge when a high-frequency is inputted to the electrode.

This application is based on Japanese patent application No. 2009-097188 the content of which is incorporated hereinto by reference.

### BACKGROUND

1. Technical Field

The present invention relates to a plasma processing apparatus, fault detection apparatus, and fault detection method which are capable of detecting faults in a mass flow controller.

2. Related Art

Plasma processing apparatus are apparatus for introducing process gas into a processing chamber and carrying out processing by causing a plasma to be generated as a result of applying a high-frequency to the process gas. Processing conditions for a plasma processing apparatus are constituted by pressure within the processing chamber and the flow rate of the process gas. The flow rate of the process gas can be regulated by a mass flow controller (see Japanese Laid-Open patent publication NO. 2000-077394, 2004-062897, 2007-027661 and Japanese Published patent application A-H08-288222, for example).

The present inventor has recognized as follows. The pressure within the processing chamber can be controlled, for example, as a result of regulating an extent of opening of a pressure regulating valve provided at an exhaust pipe.

### SUMMARY

When a fault occurs at the mass flow controller, a fault occurs in the processing at the plasma processing apparatus because the flow rate for the process gas introduced to within the processing chamber deviates from the desired quantity. This means that it is therefore important to detect faults in the mass flow controller.

It can therefore be considered to provide a separate gas flow meter in piping where the mass flow controller is located as a method of detecting faults in the mass flow controller. However, as space is required for locating the gas flow meter in this method, there are cases where this is not appropriate due to there not being any excess space. Cases where faults in the mass flow controller are caused by product material within the piping are common. It is therefore also conceivable that faults will occur at the gas flow meter when faults occur at the mass flow controller.

It is therefore necessary to detect faults in the mass flow controller even if a gas flow meter is not provided in the piping where the mass flow controller is located.

In one embodiment, there is provided a plasma processing apparatus comprises:

a processing chamber;

an electrode, located within the processing chamber, subjected to application of a high-frequency;

gas introduction piping introducing process gas for use in plasma generation into the processing chamber;

a mass flow controller, located in the gas introduction piping, adjusting gas flow of the process gas;

a pressure gauge detecting pressure within the processing chamber;

a control unit controlling pressure within the processing chamber based on values detected by the pressure gauge; and

a fault detection unit that receives flow rate data indicating a flow rate of the process gas from the mass flow controller, and determines the presence or absence of faults at the mass flow controller based on the flow rate data and an extent of fluctuation of values detected by the pressure gauge when a high-frequency is inputted to the electrode.

According to the embodiment, pressure within the processing chamber is controlled by the control unit. In this situation, when a high-frequency is applied to the electrode, the process gas is ionized so as to create a plasma. When a plasma is formed, the number of particles such as molecules, atoms, and radicals within the processing chamber increases due to the process gas being partially dissolved so as to give the same state as if the process gas has increased. Control of the pressure adjustment valve by the control unit cannot soon follow increases in the process gas. The values detected by the pressure gauge therefore instantaneously rise when a high-frequency is inputted to the electrode. The extent of this increase is greater for a greater flow of process gas. It is therefore possible to determine whether or not flow rate of the process gas is a stipulated value, i.e. determine the presence or absence of a fault at the mass flow controller, based on the extent of fluctuation of the values detected by the pressure gauge.

In another embodiment, there is also provided in a fault detection apparatus that detects faults in a mass flow controller fitted to a plasma processing apparatus,

the plasma processing apparatus comprises:

a processing chamber;

an electrode, located within the processing chamber, subjected to application of a high-frequency;

gas introduction piping introducing process gas for use in plasma generation into the processing chamber;

a mass flow controller, located in the gas introduction piping, adjusting gas flow of the process gas;

a pressure gauge detecting pressure within the processing chamber;

a control unit controlling pressure within the processing chamber based on values detected by the pressure gauge; and

a fault detection unit that receives flow rate data indicating a flow rate of the process gas from the mass flow controller, and determines the presence or absence of faults at the mass flow controller based on the flow rate data and an extent of fluctuation of values detected by the pressure gauge when a high-frequency is inputted to the electrode,

wherein flow rate data indicating a flow rate of the process gas is received from the mass flow controller, and the presence or absence of a fault at the mass flow controller is determined based on the flow rate data and an extent of fluctuation of values detected by the pressure gauge when a high-frequency is inputted to the electrode.

In another embodiment, there is also provided in a fault detection method that detects faults in a mass flow controller fitted to a plasma processing apparatus,

the plasma processing apparatus comprises:

a processing chamber;

an electrode, located within the processing chamber, subjected to application of a high-frequency;

gas introduction piping introducing process gas for use in plasma generation into the processing chamber;

a mass flow controller, located in the gas introduction piping, adjusting gas flow of the process gas;

a pressure gauge detecting pressure within the processing chamber;

a control unit controlling pressure within the processing chamber based on values detected by the pressure gauge; and

a fault detection unit that receives flow rate data indicating a flow rate of the process gas from the mass flow controller, and determines the presence or absence of faults at the mass flow controller based on the flow rate data and an extent of fluctuation of values detected by the pressure gauge when a high-frequency is inputted to the electrode, and

the method comprises:

judging the presence or absence of a fault at the mass flow controller based on the flow rate data and an extent of fluctuation of values detected by the pressure gauge when a high-frequency is inputted to the electrode.

According to the embodiments, it is possible to detect faults in a mass flow controller even if a gas flow meter is not provided in the piping where the mass flow controller is located.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a view illustrating a configuration for a plasma processing apparatus of a preferred embodiment;

FIG. 2 is a view illustrating that determination logic of a control unit is valid;

FIG. 3 is a further view illustrating that determination logic of a control unit is valid; and

FIG. 4 is a flowchart illustrating a method for carrying out processing using the plasma processing apparatus illustrated in FIG. 1.

### DETAILED DESCRIPTION OF PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Exemplary embodiments of the present invention are explained in the following using the drawings. Elements of the configuration that are the same are given the same numerals in all of the diagrams and descriptions thereof are omitted as appropriate.

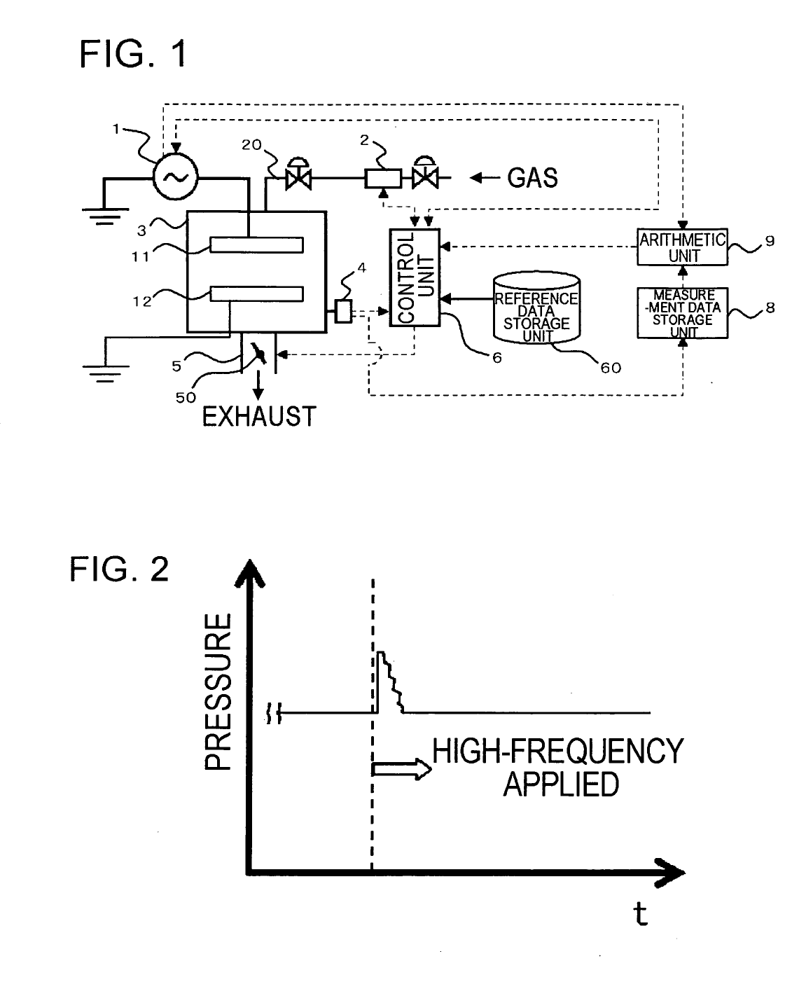

FIG. 1 is a view illustrating a configuration for a plasma processing apparatus of the preferred embodiment. The plasma processing apparatus is equipped with a processing chamber 3, an electrode 11, gas introduction piping 20, an exhaust pipe 5, a pressure regulating valve 50, a mass flow controller 2, a pressure gauge 4, and a control unit 6. The control unit 6 doubles as a fault detection unit. The plasma processing apparatus is, for example, a plasma CVD apparatus, a sputtering apparatus, or an etching apparatus.

The electrode 11 is located within the processing chamber 3 and is subjected to a high-frequency by a high-frequency source. The gas introduction piping 20 introduces process gas for plasma generation into the processing chamber 3. The exhaust pipe 5 is connected to an exhaust pump (not shown) and evacuates the processing chamber 3. The pressure regulating valve 50 is provided at the exhaust pipe 5. The mass flow controller 2 is provided at the gas introduction piping 20 and regulates the flow rate of the process gas. The pressure gauge 4 detects the pressure of the processing chamber 3. The control unit 6 controls pressure within the processing chamber 3 by controlling an extent of opening of the pressure regulating valve 50 based on ,values detected by the pressure gauge 4. The control unit 6 receives flow rate data indicating the rate of flow of process gas from the mass flow controller 2 and determines the presence or absence of faults of the mass flow controller 2 based on flow rate data and an extent of fluctuation of the values detected by the pressure gauge 4 when high-frequencies are inputted to the electrode.

The control unit 6 also controls a high-frequency source 1 and the mass flow controller 2. An electrode 12 is also provided within the processing chamber 3. The electrode 12 faces the electrode 11 and is connected to earth.

In this embodiment, the plasma processing apparatus is equipped with a measurement data storage unit 8 and an arithmetic unit 9. The measurement data storage unit 8 can store the values detected by the pressure gauge 4 for a fixed period of time. The measurement data storage unit 8 starts and ends storing of values detected by the pressure gauge 4 based, for example, on instructions from the arithmetic unit 9. When a signal indicating that input of high-frequencies by the high-frequency source 1 to the electrode 11 has started, the arithmetic unit 9 reads out data stored in the measurement data storage unit 8 and calculates the extent of fluctuation of the values detected by the pressure gauge 4 when high-frequencies are inputted to the electrode 11. The arithmetic unit 9 then outputs the calculated extent of fluctuation to the control unit 6.

The plasma processing apparatus is equipped with a reference data storage unit 60. The reference data storage unit 60 stores reference data. The reference data is data indicating the relationship between reference values for values detected by the pressure gauge 4 when a high-frequency is inputted to the electrode 11 and the flow rate of the process gas. The reference data can be for a method indicating the relationship between the reference values and the flow rate for the process gas or can be data where separate reference values for the flow rate of the process gas is indicated in a table format. The control unit 6 determines that there is a fault at the mass flow controller 2 when a difference between a reference value indicated by the reference data and an extent of fluctuation of the value detected by the pressure gauge 4 is equal to or more than a reference value.

The control unit 6, the measurement data storage unit 8, and the arithmetic unit 9 function as a fault detection apparatus for detecting faults of the mass flow controller 2.

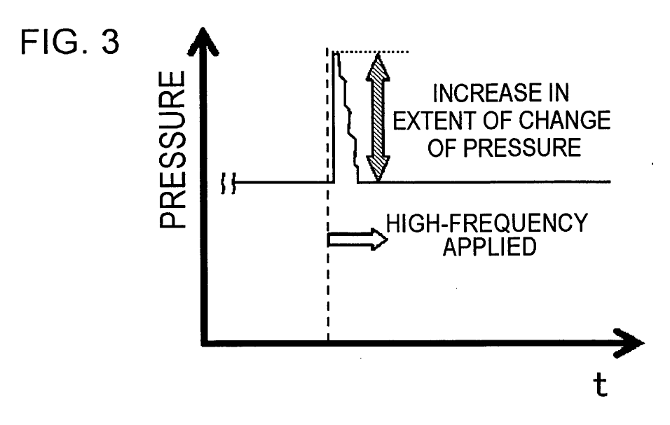

FIGS. 2 and 3 are views illustrating the validity of the determination logic of the control unit 6. When a high-frequency is applied to the electrode 11, the process gas within the processing chamber 3 is ionized and a plasma is formed. When a plasma is formed, the number of particles such as molecules, atoms, and radicals within the processing chamber increases due to the process gas being partially dissolved so as to give the same state as if the process gas has increased. Control of the pressure regulating valve 50 by the control unit 6 cannot soon following the increases in this process gas. The values detected by the pressure gauge 4 therefore instantaneously rise when a high-frequency is inputted to the electrode 11.

Plasma generation commences from when the pressure within the processing chamber 3 is stable and a rise in the values detected by the pressure gauge 4 caused by the generation of the plasma can be easily detected. This rise fluctuates depending on the flow rate of the process gas, as illustrated in FIGS. 2 and 3. Specifically, this rise increases as the flow rate of the process gas increases. In the event that a flow rate of the process gas for where there is a fault occurring at the mass flow controller 2 fluctuates, this rise also fluctuates. The control unit 6 can therefore detect that a fault is occurring at the mass flow controller 2.

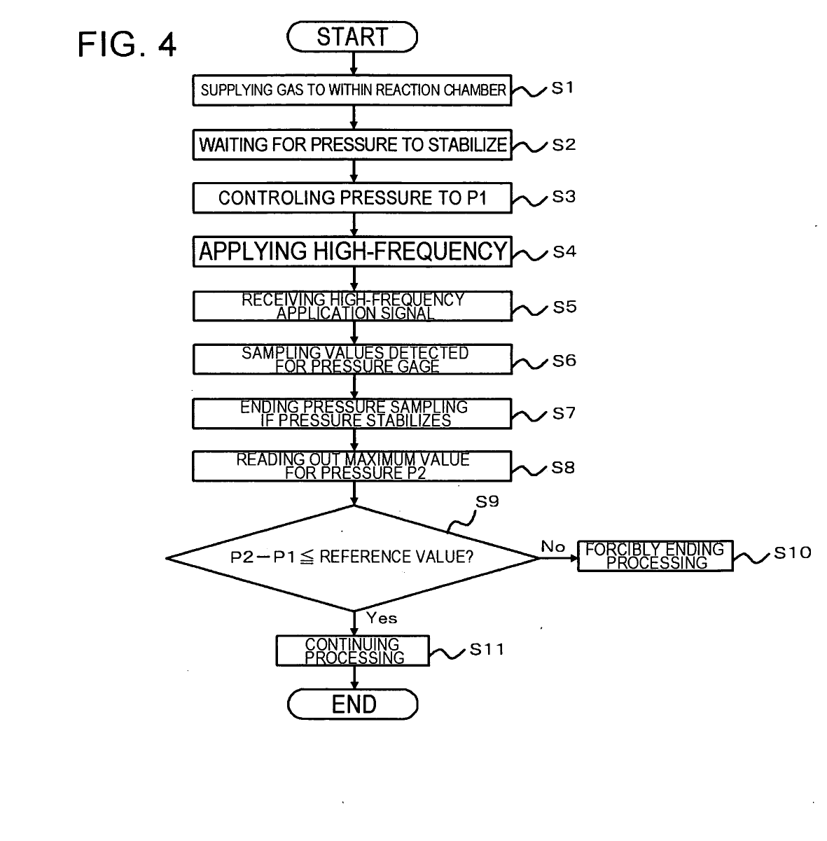

FIG. 4 is a flowchart illustrating a method for carrying out processing using the plasma processing apparatus illustrated in FIG. 1. First, the control unit 6 controls the mass flow controller 2 and starts to supply process gas to within the processing chamber 3 (step S1). The control unit 6 then ensures that the pressure within the processing chamber 3 is stable (step S2), ensures that the pressure within the processing chamber 3 becomes a preset value (21) (step S3), and starts inputting a high-frequency to the electrode 11 using the high-frequency source 1 (step S4).

When the high-frequency source 1 starts to input high-frequencies to the electrode 11, a high-frequency application signal indicating that inputting of the high-frequency has started is outputted to the arithmetic unit 9. Upon receiving the high-frequency application signal (step S5), the arithmetic unit 9 samples values detected for the pressure gauge 4 for storage in the measurement data storage unit 8 (step S6). The sampling period for the values detected by the pressure gauge 4 is, for example, equal to or less than one hundred milliseconds. When the values detected for the pressure gauge 4 stabilize at P1, the arithmetic unit 9 ends sampling of the values detected for the pressure gauge 4 and storage at the measurement data storage unit 8 (step S7).

The arithmetic unit 9 then reads out a maximum value P2 for the values detected by the pressure gauge 4 stored in the measurement data storage unit 8 (step S8), calculates a difference between this value P2 and P1 that is a pressure within the processing chamber 3 for directly before the generation of the plasma and outputs this difference to the control unit 6.

Upon receiving the difference between P2 and P1 from the arithmetic unit 9, the control unit 6 recognizes the set reference value corresponding to the flow rate of the process gas using the data stored by the reference data storage unit 60. When the difference between P2 and P1 is larger than the reference value (i.e. change in pressure at a standard time) (step S9: No), the control unit 6 determines that a fault is occurring at the mass flow controller 2 and forcibly ends processing by the plasma processing apparatus (step S10). When the difference between P2 and P1 is smaller than this reference value (i.e. the change in pressure at the standard time) (step S9: Yes), processing by the plasma processing apparatus is continued (step S11).

In step S9, the control unit 6 can also determine that there is a fault at the mass flow controller 2 when the difference between P2 and P1 and the difference with a reference value (i.e. a change in pressure at the reference time) is outside a preset range.

According to the above embodiment, the control unit 6 can determine the presence or absence of a fault at the mass flow controller 2 based on fluctuations in the pressure of the processing chamber 3 when a high-frequency is applied to the electrode 11. It is therefore possible to detect faults in the mass flow controller 2 even if a gas flow meter is not provided in the piping where the mass flow controller 2 is located. Products for which there is the chance of failure occurring are therefore suppressed from the process flow thereafter because the operation of the plasma processing apparatus is forcibly ended when a fault is detected in the mass flow controller 2.

Further, when a high-frequency application signal indicating that application of a high-frequency to the electrode 11 has started is received, the measurement data storage unit 8 starts to store values detected by the pressure gauge 4 and ends storage of values detected by the pressure gauge 4 when values detected by the pressure gauge 4 stabilize. It is therefore possible to reduce the storage capacity required at the measurement data storage unit 8.

It is also possible for the measurement data storage unit 8 to always store the values detected by the pressure gauge 4. The measurement data storage unit 8 can also store the values detected by the pressure gauge 4 for a fixed time. The sampling period for the values detected by the pressure gauge 4 is, for example, equal to or less than one hundred milliseconds. When the value detected by the pressure gauge 4 stabilizes, the maximum value P2 for the values detected by the pressure gauge 4 stored in the measurement data storage unit 8 is read out by the control unit 6. A difference between P2 and P1 that is the pressure within the processing chamber directly before plasma generation is then calculated and outputted to the control unit 6.

A description is given in the above of embodiments of the present invention with reference to the drawings but these merely exemplify the present invention and various configurations other than those above can also be adopted.

It is apparent that the present invention is not limited to the above embodiments, but may be modified and changed without departing from the scope and spirit of the invention.

What is claimed is:

1. A plasma processing apparatus comprising:
a processing chamber;
an electrode, located within said processing chamber, subjected to application of a high-frequency;
gas introduction piping introducing process gas for use in plasma generation into said processing chamber;
a mass flow controller, located in said gas introduction piping, adjusting flow rate of said process gas;
a pressure gauge detecting pressure within said processing chamber;
a control unit controlling pressure within said processing chamber based on values detected by said pressure gauge; and
a fault detection unit that receives flow rate data indicating a flow rate of said process gas from said mass flow controller, and determines the presence or absence of faults at said mass flow controller based on said flow rate data and an extent of fluctuation of values detected by said pressure gauge when a high-frequency is inputted to said electrode.

2. The plasma processing apparatus according to claim 1,
further comprising a reference data storage unit storing reference data indicating a relationship between a flow rate of said process gas and reference values for an extent of fluctuation of values detected by said pressure gauge when said high-frequency is inputted to said electrode,
wherein said fault detection unit determines that there is a fault at said mass flow controller when a difference between said reference value indicated by said reference data and said extent of fluctuation of said values detected by said pressure gauge is equal to or greater than a reference.

3. The plasma processing apparatus according to claim 1,
further comprising a measuring data storage unit that starts storing values detected by said pressure gauge when a high-frequency application signal indicating that application of a high-frequency to said electrode has started is received, and ends storage of said values detected by said pressure gauge when said values detected by said pressure gauge stabilize,
wherein said fault detection unit calculates said extent of fluctuation of said values detected by said pressure gauge using a maximum value for said values detected by said pressure gauge stored by said measurement data storage unit.

4. A fault detection apparatus that detects faults in a mass flow controller fitted to a plasma processing apparatus,
said plasma processing apparatus comprising:
a plasma processing apparatus comprising: a processing chamber;
an electrode, located within said processing chamber, subjected to application of a high-frequency;
gas introduction piping introducing process gas for use in plasma generation into said processing chamber;
a mass flow controller, located in said gas introduction piping, adjusting gas flow of said process gas;
a pressure gauge detecting pressure within said processing chamber;
a control unit controlling pressure within said processing chamber based on values detected by said pressure gauge; and
a fault detection unit that receives flow rate data indicating a flow rate of said process gas from said mass flow controller, and determines the presence or absence of faults at said mass flow controller based on said flow rate data and an extent of fluctuation of values detected by said pressure gauge when a high-frequency is inputted to said electrode,
wherein flow rate data indicating a flow rate of said process gas is received from said mass flow controller, and the presence or absence of a fault at said mass flow controller is determined based on said flow rate data and an extent of fluctuation of values detected by said pressure gauge when a high-frequency is inputted to said electrode.

5. A fault detection method that detects faults in a mass flow controller fitted to a plasma processing apparatus,
said plasma processing apparatus comprising:
a processing chamber;
an electrode, located within said processing chamber, subjected to application of a high-frequency;
gas introduction piping introducing process gas for use in plasma generation into said processing chamber;
a mass flow controller, located in said gas introduction piping, adjusting as flow of said process gas;
a pressure gauge detecting pressure within said processing chamber;
a control unit controlling pressure within said processing chamber based on values detected by said pressure gauge; and
a fault detection unit that receives flow rate data indicating a flow rate of said process gas from said mass flow controller, and determines the presence or absence of faults at said mass flow controller based on said flow rate data and an extent of fluctuation of values detected by said pressure gauge when a high-frequency is inputted to said electrode, and
said method comprising:
judging the presence or absence of faults at said mass flow controller based on said flow rate data indicating a rate of flow of said process gas indicated by said mass flow controller and an extent of fluctuation of values detected by said pressure gauge when a high-frequency is inputted to said electrode.
